(19) United States
(12) Patent Application Publication
(10) Pub. No.: US 2015/0240861 A1
(43) Pub. Date: Aug. 27, 2015

(54) SNAP HOOK

(71) Applicant: CAPITAL SAFETY GROUP (AUSTRALIA) PTY LIMITED, Silverwater, New South Wales (AU)

(72) Inventor: Richard Hugh Millar, Silverwater (AU)

(73) Assignee: CAPITAL SAFETY GROUP (AUSTRALIA) PTY LIMITED, Silverwater, New South Wales (AU)

(21) Appl. No.: 14/427,070

(22) PCT Filed: Apr. 24, 2013
(86) PCT No.: PCT/AU2013/000418

§ 371 Date: Mar. 10, 2015

(30) Foreign Application Priority Data
Sep. 11, 2012 (AU) 2012903963

(51) Int. Cl. F16B 45/02

(52) U.S. Cl. CPC F16B 45/02

(57) ABSTRACT

The present invention relates broadly to an improved snap hook (10) comprising a hook member (12), a gate member (14) pivotally connected to the hook member (12), a catch member (16) moveable connected to the hook member (12), and a latch member (18) movably mounted to the catch member (16). The hook member (12) is generally C-shaped including an opening (20) across which the gate member (14) extends in its closed position. The gate member (14) pivots about a gate pivot pin (22) fitted to the hook member (12). The catch member (16) pivots about a catch pivot pin (24) also fitted to the hook member (12). The latch member (18) is in this embodiment slidably mounted to the catch member (16). The catch member (16) is operatively coupled to the gate member (14) to in a catched position retain the gate member (14) in the closed position. The latch member (18) is arranged in a latched position to engage the hook member (12) to restrict movement of the catch member (16) to maintain it in the catched position. The gate member (14) is maintained in the closed position with the catch member (16) in the catched position.

### FIELD OF THE INVENTION

The present invention relates broadly to an improved snap hook.

### BACKGROUND TO THE INVENTION

Snap hooks of a conventional design having high safety requirements often include multiple latches designed to prevent inadvertent opening of a gate of the snap hook. In a triple-action snap hook a safety heel is pivotally mounted to the snap hook and arranged to abut a pivotal catch which cooperates with the gate to hold it closed. To open the snap hook a user must first pivot the safety heel to permit pivoting of the catch to unlatch it from the gate to allow opening of the gate. The safety heel is located adjacent the gate on an opposite side of the snap hook to the catch. The user grips the snap hook and pivots the safety heel with their little or ring finger to release it from the catch. The catch can be pressed inward via the palm of the user's hand to unlatch it and permit opening of the gate. It will be appreciated that this technique for opening the tripe-action snap hook is awkward requiring a high degree of user dexterity. It also exposes the user to various pinch points in the device.

It is to be understood that any acknowledge of prior art in this specification is not to be taken as an admission that this prior art forms part of the common general knowledge.

### SUMMARY OF THE INVENTION

According to the present invention there is provided an improved snap hook comprising:

a hook member including an opening;

a gate member pivotally connected to the hook member across the opening;

a catch member movably connected to the hook member and operatively coupled to the gate member to in a catched position retain the gate member in a closed position;

a latch member movably mounted to the catch member and arranged in a latched position to engage the hook member to at least restrict movement of the catch member to maintain it in the catched position and thus the gate member in the closed position.

Preferably the latch member is slidably mounted to the catch member and arranged in the latched position to abut the hook member. More preferably the snap hook also comprises latch biasing means operatively coupled to the latch member to bias it into the latched position. Even more preferably the latch biasing means includes a compression spring.

Preferably the catch member is pivotally connected to the hook member for pivotal movement between the catched position and an uncatched position where pivotal movement of the gate member away from the closed position is permitted. More preferably the catch member includes a catch recess configured in the catched position to catch a projection of the gate member in the closed position, and in the uncatched position to allow sliding movement of the projection relative to the catch member with the associated pivotal movement of the gate member away from the closed position. Even more preferably the snap hook further comprises catch biasing means operatively coupled to the catch member to bias it into the catched position.

Preferably the latch member includes an actuator slidably coupled to the catch member via an abutment member. More preferably the abutment member is elongated and at one end configured to abut the hook member with the latch member in the latched position. Even more preferably the actuator is adapted to permit sliding movement of the latch member into the unlatched position and pivotal movement of the catch member between the catched and the uncatched positions.

Preferably the snap hook also comprises gate biasing means operatively coupled to the gate member to bias it toward the closed position.

Generally the improved snap hook is a safety hook, a Karabiner or a scaffold hook.

### BRIEF DESCRIPTION OF THE DRAWINGS

In order to achieve a better understanding of the nature of the present invention a preferred embodiment of an improved snap hook will now be described, by way of example, with reference to the accompanying drawings in which:

FIG. 1 is a side view of an improved snap hook according to an embodiment of the invention;

FIG. 2 is a side view shown partly exploded of the improved snap hook of FIG. 1;

FIG. 3 is a side view of the improved snap hook of FIGS. 1 and 2 with the latch member in an unlatched position;

FIG. 4 is a side view of the improved snap hook of the preceding figures with the latch member in the unlatched position and the gate member in an open position;

FIG. 5 is a side view of an improved snap hook of another embodiment shown in part sectional view and without the gate member;

FIG. 6 are various side, end, sectional and perspective views of the latch and catch members taken from the snap hook of FIG. 5;

FIG. 7 is a side view of an improved snap hook of a further embodiment shown in section with part only of the hook member.

### DETAILED DESCRIPTION OF THE PREFERRED EMBODIMENT

As shown in all figures there is an improved snap hook 10 comprising a hook member 12, a gate member 14 pivotally connected to the hook member 12, a catch member 16 movably connected to the hook member 12, and a latch member 18 movably mounted to the catch member 16. The hook member 12 is in this embodiment generally C-shaped including an opening 20 across which the gate member 14 extends in its closed position. The gate member 14 pivots about a gate pivot pin 22 fitted to the hook member 12. The catch member 16 pivots about a catch pivot pin 24 also fitted to the hook member 12. The latch member 18 is in this embodiment slidably mounted to the catch member 16.

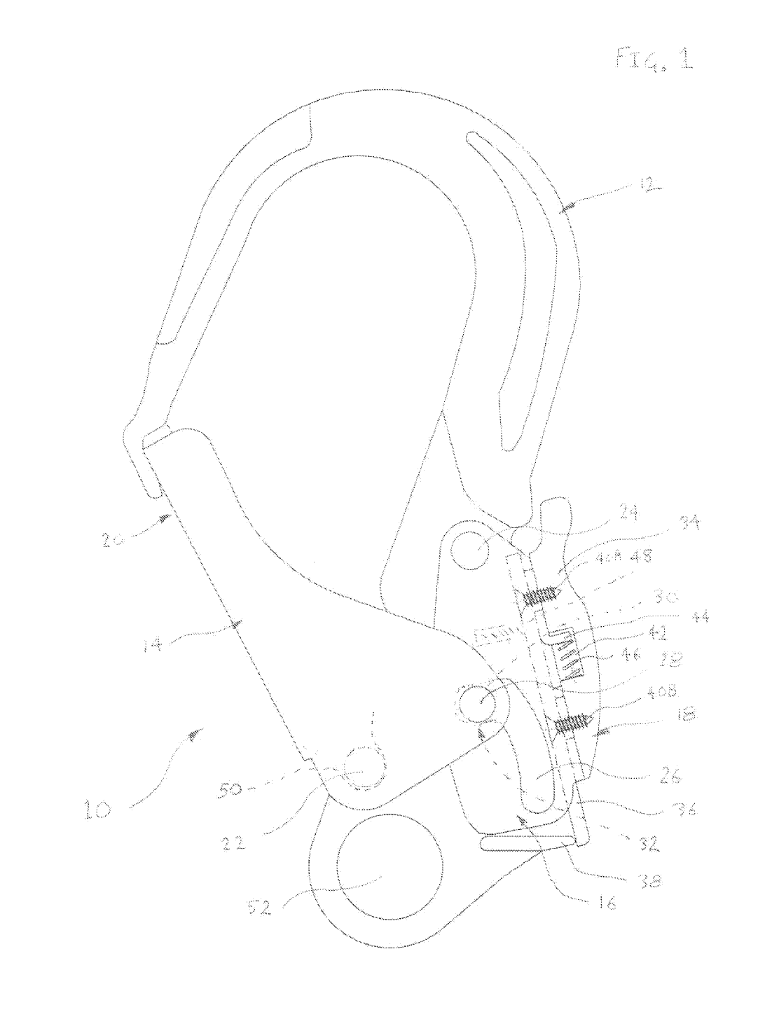

The catch member 16 is operatively coupled to the gate member 14 to in a catched position retain the gate member 14 in the closed position. The latch member 18 is arranged in a latched position to engage the hook member 12 to restrict movement of the catch member 16 to maintain it in the catched position. The gate member 14 is maintained in the closed position with the catch member 16 in the catched position (see FIG. 1).

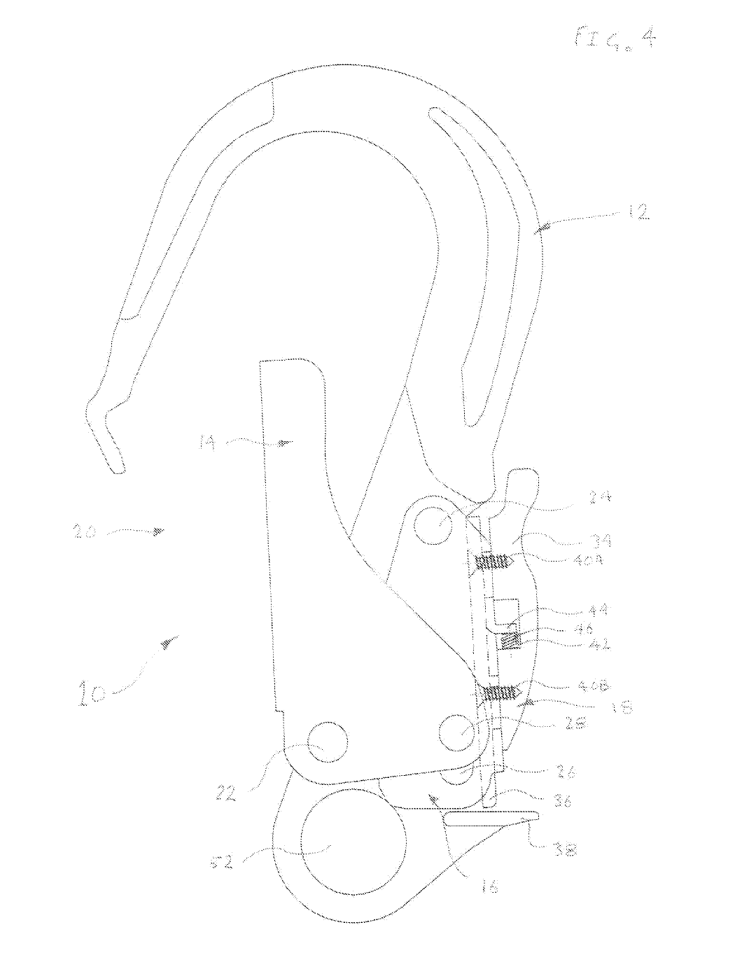

The catch member 16 includes a catch recess 26 configured to cooperate with a projection 28 of the gate member 14. The catch recess 26 is shaped generally arcuate to allow sliding movement of the projection 28 with pivotal movement of the gate member 14 away from the closed position. This pivotal movement of the gate member 14 is only allowed with the latched member 18 in an unlatched position to permit pivotal movement of the catch member 16 into an uncatched position (see FIG. 4). The arcuate-shaped catch recess 26 includes a rebate 30 configured to cooperate with the projection 28 of the gate member 14 on pivotal movement of the catch member 16. The rebate 30 is generally curve-shaped having a radius centred about the catch pivot pin 24. The curve-shaped rebate 30 is formed continuous with the arcuate-shaped recess 26. The curve-shaped rebate 30 defines a shoulder 32 in the catch member 16 which abuts with the projection 28 of the gate member 14 to maintain it in the closed position.

The latch member 18 of this embodiment includes an actuator 34 slidably coupled or secured to the catch member 16 via abutment member or plate 36. The abutment plate 36 in the latched position is configured to abut a foot 38 of the hook member 12 (see FIG. 1). The abutment plate 36 is located predominantly inside the catch member 16 and fastened to the actuator 34 via screw fasteners 40A and 40B. The actuator 34 is located outside the catch member 16. The actuator 34 includes a cavity 42 configured to slidably receive a protruding tongue 44 mounted to the catch member 16. The snap hook 10 is also provided with latch biasing means in the form of a latch compression spring 46 housed within the cavity 42 and bearing against the protruding tongue 44. The latch compression spring 46 thus operates to bias the latch member 18 into the latched position.

The improved snap hook 10 of this embodiment also comprises catch biasing means in the form of catch compression spring 48 operatively coupled to the catch member 16 to bias it into the catched position (see FIG. 1). The projection 28 of the gate member 14 bears against an end of the curve-shaped rebate 30 to limit pivotal movement of the catch member 16 away from the hook member 12 under the biasing force of the catch compression spring 48. The improved snap hook 10 is designed so that in this position with the catch member 16 in the catched position and the projection 28 abutting the shoulder 32, the abutment plate 36 is disposed adjacent the foot 38 of the hook member 12 for abutment. The latch compression spring 46 maintains the latch member 18 in this latched position to prevent pivotal movement of the catch member 16 and pivotal movement of the gate member 14 which is thus held in the closed position.

The improved snap hook 10 of this example also comprises gate biasing means in the form of a torsion spring 50. The torsion spring 50 is mounted to the gate pivot pin 22 and coupled to the gate member 14 to bias it toward the closed position. The snap hook 10 is designed so that in the closed position the projection 28 of the latch member 14 rests within the curve-shaped rebate 30 of the catch member 16 in its catched position.

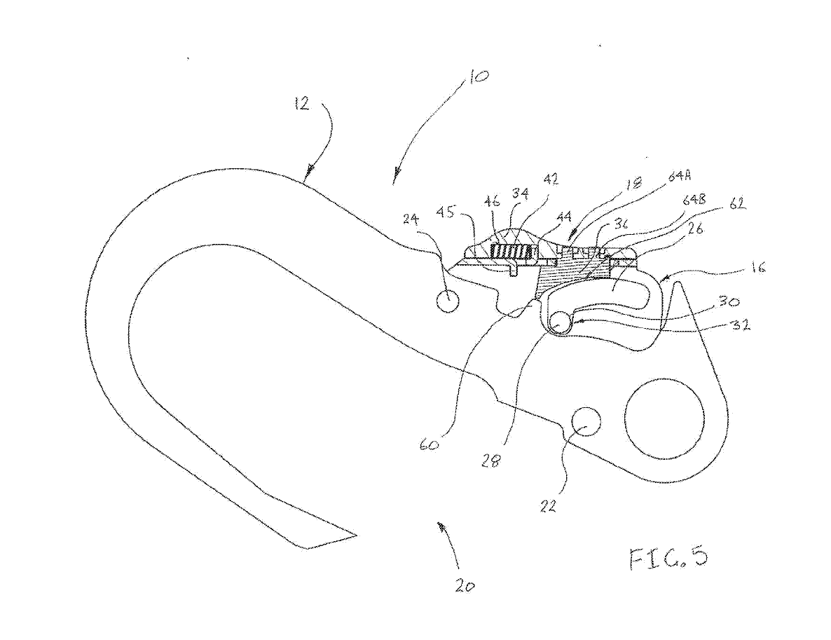

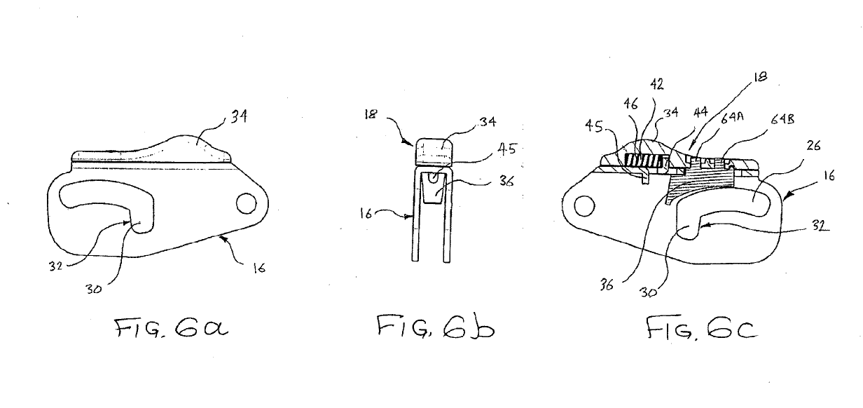

FIGS. 5 and 6 illustrate another embodiment of an improved snap hook 10 according to the present invention. For ease of reference and in order to avoid repetition like components of this and the earlier embodiment of the snap hook have been designated with the same reference numeral.

In this other embodiment the latch member 18 is under the influence of the latch compression spring 46 biased in an opposite direction to the previous embodiment. The latch member 18 is biased into its latched position wherein the abutment member 36 abuts the hook member 12 at an intermediate protrusion 60. The abutment member 36 in this embodiment is wedge-shaped so that its inside face 62 substantially contours to the profile of the arcuate-shaped recess 26. The ensures that on unlatching of the latch member 18 and pivotal movement of the catch member 16, the projection 28 of the gate member 14 is clear to slidably move within the catch recess 26 on pivotal movement of the gate member 14 away from the closed position. In this embodiment the wedge-shaped abutment member 36 is riveted to the actuator 34 via rivet members 64A and 64B.

The protruding tongue 44 is in this other embodiment an integral part of the catch member 16. The catch member 16 also includes a tab 45 which points in an opposite direction to the tongue 44. The tab 45 engages a spring (not shown) housed in the hook member 12 to bias the catch member 16 outward of the hook member 12.

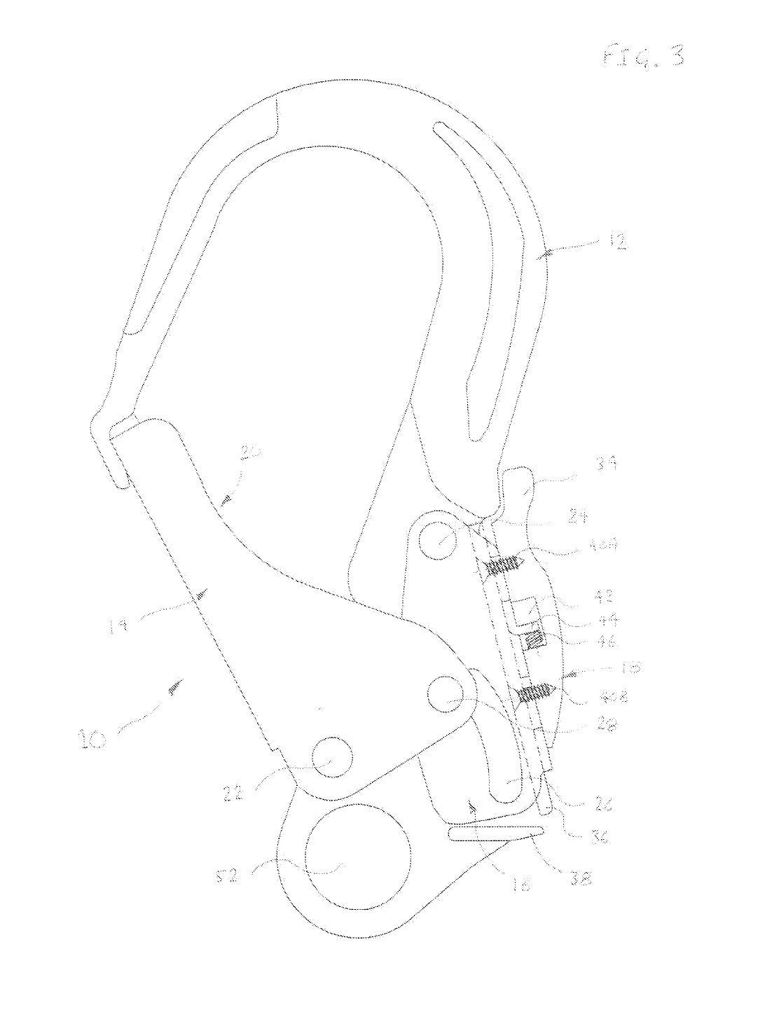

For an improved understanding of the present invention, operation of the improved snap hooks 10 of the previous embodiments will now be described. The general steps involved in operation of the improved snap hooks 10 are as follows:
1. The latch member 18 is slid via a user's thumb of one hand against the biasing force of the latch compression spring 46 toward an unlatched position (see for example FIG. 3) where the abutment member 36 is released from abutment with the hook member 12;
2. The catch member 16 is pivoted inward and toward an uncatched position;
3. The gate member 14 is pressed (either by the index and/or middle fingers of the user's hand, or an article to which the snap hook is to be connected) to pivot the gate member 14 toward its open position to expose the opening 20 of the hook member 12 wherein the projection 28 of the gate member 14 slidably moves along the arcuate recess 26 of the catch member 16 (see FIG. 4).

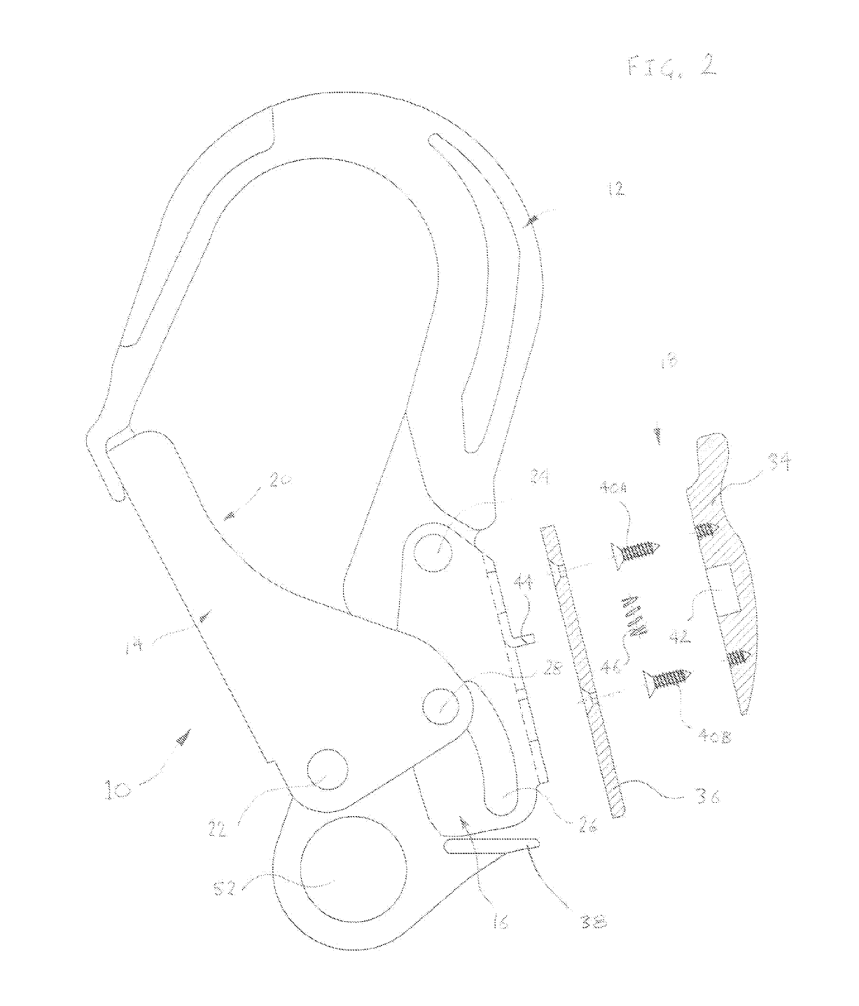

In step 1 of the first embodiment of FIGS. 1 to 4 the latch member 18 is slid away from the users palm (toward the hook member 12) whereas in the second embodiment of FIGS. 5 and 6 the latch member 18 is drawn toward the palm of the user. In step 2 of the first embodiment the catch member 16 is pivoted inward by contact of the user's palm with the actuator 34. In step 2 of the second embodiment the user's thumb can both draw the latch member 18 back & press the catch member 16 inward.

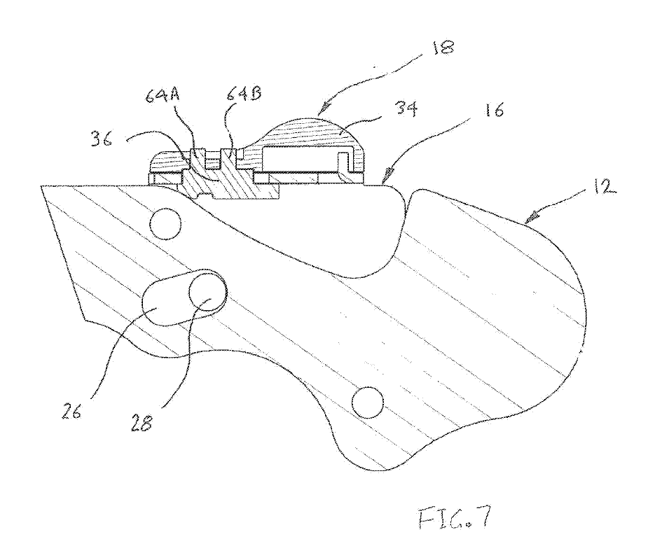

FIG. 7 illustrates a further embodiment of an improved snap hook 10 according to the present invention. This embodiment has corresponding components to the previous embodiments but is adapted in its shape and configuration to suit the particular hook member 12 to which it is fitted. The abutment member 36 is wedge-shaped for abutment with the hook member 12 to prevent pivotal movement of the catch member 16. The actuator 34 is shaped similar to the previous embodiment but reversed so that its retraction toward the foot of the hook member 12 releases the wedge-shaped abutment member 36 from the hook member 12 for unlatching of the latch member 18. The catch member 16 is then free to pivot to its uncatched position to allow opening of the gate member 14

The improved snap hook 10 is in this embodiment a scaffold hook. However, it will be appreciated that the improved snap hook may extend to other styles of snap hooks having other applications such as a safety hook or a Karabiner. The scaffold hook 10 of this example is typically connected to the end of a lanyard (not shown) via its anchor point defined by opening 52 with the other end of the lanyard connected to a safety harness (also not shown) worn by a user.

Now that a preferred embodiment of the present invention has been described it will be apparent to those skilled in the art that the improved snap hook has at least the following advantages:
1. The snap hook can be operated with relative ease requiring a lower degree of user dexterity compared to the prior art;
2. The snap hook is safe maintaining the triple action of the general design of the prior art;
3. The improved snap hook is of a design which lends itself to a range of hook formations without departing greatly from existing shapes.

Those skilled in the art will appreciate that the invention described herein is susceptible to variations and modifications other than those specifically described. For example, the latch member is not limited to the sliding movement described but may also extend to other movements provided it is moveably mounted to the catch member. The catch member need not be limited to pivotal movement but may also slidably move relative to the hook member for retention of the gate member in its closed position. The biasing means described may vary where for example the compression spring of the catch member is replaced with a torsion spring fitted to the catch member pin. All such variations and modifications are to be considered within the scope of the present invention the nature of which is to be determined from the foregoing description.

1. An improved snap hook comprising:
a hook member including an opening;
a gate member pivotally connected to the hook member across the opening;
a catch member movably connected to the hook member and operatively coupled to the gate member to in a catched position retain the gate member in a closed position;
a latch member movably mounted to the catch member and arranged in a latched position to engage the hook member to at least restrict movement of the catch member to maintain it in the catched position and thus the gate member in the closed position.

2. An improved snap hook as defined in claim 1 wherein the latch member is slidably mounted to the catch member and arranged in the latched position to abut the hook member.

3. An improved snap hook as defined in claim 1 further comprising a latch biasing member operatively coupled to the latch member to bias it into the latched position.

4. An improved snap hook as defined in claim 3 wherein the latch biasing member includes a compression spring.

5. An improved snap hook as defined in claim 1 wherein the catch member is pivotally connected to the hook member for pivotal movement between the catched position and an uncatched position where pivotal movement of the gate member away from the closed position is permitted.

6. An improved snap hook as defined in claim 5 wherein the catch member includes a catch recess configured in the catched position to catch a projection of the gate member in the closed position, and in the uncatched position to allow sliding movement of the projection relative to the catch member with the associated pivotal movement of the gate member away from the closed position.

7. An improved snap hook as defined in claim 5 further comprising a catch biasing member operatively coupled to the catch member to bias it into the catched position.

8. An improved snap hook as defined in claim 5 wherein the latch member includes an actuator slidably coupled to the catch member via an abutment member.

9. An improved snap hook as defined in claim 8 wherein the abutment member is elongated and at one end configured to abut the hook member with the latch member in the latched position.

10. An improved snap hook as defined in claim 8 wherein the actuator is adapted to permit sliding movement of the latch member into the unlatched position and pivotal movement of the catch member between the catched and the uncatched positions.

11. An improved snap hook as defined in claim 1 further comprising a gate biasing member operatively coupled to the gate member to bias it toward the closed position.

12. An improved snap hook as defined in claim 8 wherein the abutment member is positioned proximate an inner surface of the catch member and the actuator is positioned proximate an outer surface of the catch member, the abutment member, the catch member, and the actuator being connected with a fastener.

13. An improved snap hook as defined in claim 12 further comprising a protrusion operatively connected to the catch member and extending into a cavity of the actuator, a latch biasing member being positioned within the cavity and placing a biasing force on the actuator and the catch member via the protrusion.

14. An improved snap hook as defined in claim 8 further comprising a foot operatively connected to the hook member proximate the catch member, the abutment member contacting the foot when the latch member is in the latched position thereby preventing the catch member from pivoting from the catched position to the uncatched position.
